(19) United States
(12) Patent Application Publication
(10) Pub. No.: US 2014/0327553 A1
(43) Pub. Date: Nov. 6, 2014

(54) ZERO POWER METERING CIRCUITS, SYSTEMS AND METHODS

(71) Applicant: Cypress Semiconductor Corporation, San Jose, CA (US)

(72) Inventors: Mark R. Whitaker, Colorado Springs, CO (US); Douglas D. Moran, Carlsbad, CA (US); Craig Taylor, Colorado Springs, CO (US)

(73) Assignee: Cypress Semiconductor Corporation, San Jose, CA (US)

(21) Appl. No.: 14/037,687

(22) Filed: Sep. 26, 2013

Related U.S. Application Data
(60) Provisional application No. 61/819,055, filed on May 3, 2013.

(51) Int. Cl. G01D 4/00

(52) U.S. Cl. CPC G01D 4/002
USPC 340/870.02

(57) ABSTRACT

A system can include a passive wireless interface circuit that generates data from a wireless signal and further includes an energy harvesting circuit that generates first operating power from the wireless signal; a meter interface circuit configured to receive at least one input signal and second operating power from a metering device; logic circuits configured to arbitrate accesses to nonvolatile storage circuits from the passive wireless interface and meter interface circuits using the first or second operating power.

This application claims the benefit of U.S. provisional patent application Ser. No. 61/819,055 filed on May 3, 2013, the contents of which are incorporated by reference herein.

### TECHNICAL FIELD

The present disclosure relates generally to metering circuits, and more particularly to zero-power metering circuits.

### BACKGROUND

Utility companies employ meters of various types to measure consumption or flow of water, gas, electricity, and the like. Typically, such meters are read manually for purposes of billing. Manual reading of meters can be a time consuming and costly endeavor and may expose the person reading the meter to various hazards associated with the ingress and egress of property. In addition, such a process can introduce the possibility of error in the documentation of meter readings.

In a metering application, a fluid (such as water) flowing through a pipe is measured in order to keep track of the volume of fluid conducted. Knowing the volume of fluid conducted over time is important for many applications such as process monitoring, safety, security and billing. The data representing the measured fluid volume can be counted and stored in a non-volatile memory. The contents of the non-volatile memory can be interrogated at a later point in time using a battery powered radio frequency identification (RFID) technology through a transponder associated with the metering application and a portable reader, for example.

One problem with conventional RFID metering applications is that, while battery power is usually available, the meter itself can be in a remote location and can be monitored infrequently. Thus, it can be critical to extend the life of batteries in such applications, to ensure power is available for the interrogation operation.

### BRIEF DESCRIPTION OF THE DRAWINGS

FIG. 1 is a block diagram of a system according to an embodiment.

FIG. 2 is a block diagram of a system according to another embodiment.

FIG. 3 is a block diagram of memory interfaces that can be included in embodiments.

FIG. 4 is a block diagram of a system according to a further embodiment.

FIG. 5 is a block diagram of a radio-frequency identification (RFID) analog interface (i/f) circuit that can be included in embodiments.

FIG. 6 is a block diagram of a RFID protocol processor that can be included in embodiments.

FIG. 7 is a block diagram of a power management circuits that can be included in embodiments.

FIG. 8 is a block diagram of a meter i/f that can be included in embodiments.

FIG. 9 is a block diagram of a nonvolatile memory that can be included in embodiments.

FIG. 10 is a block diagram of a control logic that can be included in embodiments.

FIG. 11 is a flow diagram of a method according to an embodiment.

FIG. 12 is a flow diagram of a method according to another embodiment.

FIG. 13 is a flow diagram of a method of prioritizing accesses to a metering system according to another embodiment.

### DETAILED DESCRIPTION

Various embodiments will now be described that show metering circuits, systems and methods that can be self-powered for both meter recording (e.g., storing of data in response to the meter) and wireless interrogation (e.g., data retrieval from the meter). According to embodiments, a system can include a wireless interface and a meter interface. In response to meter events, data can be stored in a non-volatile memory using power provided from, or derived from, inputs from the meter. In response to a wireless input signal (e.g., interrogation), the non-volatile memory can be accessed using power derived from the wireless signal. In this way, data-collection and transmission can be self-powered.

According to particular embodiments, a system can monitor and store meter data via a passive metering section, and can be accessed through a radio frequency identification (RFID) interface. Meter data can be stored in a nonvolatile memory. In very particular embodiments, such a nonvolatile memory can be a ferroelectric random access memory (FRAM) type memory, for very low power requirements.

In the various embodiments shown below, like sections are referred to with the same reference characters but with the leading digit(s) corresponding to the figure number.

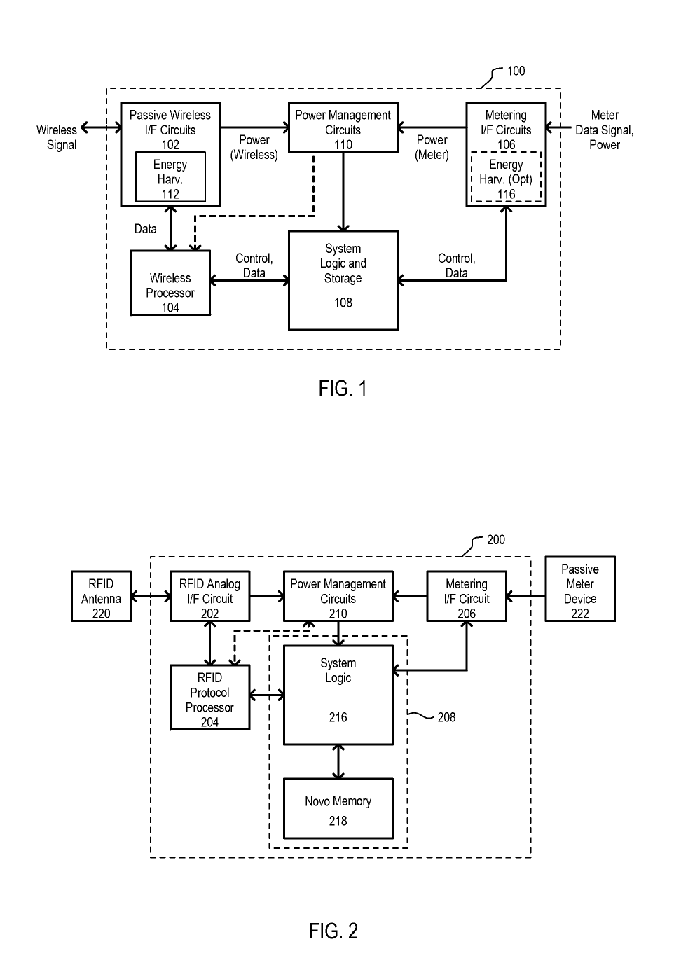

Referring to FIG. 1, a system 100 according to an embodiment is shown in block schematic diagram. A system 100 can include a passive wireless interface (i/f) 102, a wireless processor circuit 104, a meter i/f 106, system logic and storage 108, and power management circuits 110. A passive wireless i/f 102 can receive a predetermined wireless signal, and derive data and power from such a signal. In addition, passive wireless i/f 102 can transmit a wireless signal in response to a received wireless signal. In the embodiment shown, passive wireless i/f 102 can include a wireless energy harvesting circuit 112, which can generate operating power for the system according to a received wireless carrier. Thus, as shown in FIG. 1, passive wireless i/f 102 can provide power to power management circuits 110, as well as provide data signals to, and/or receive data signals from, wireless processor circuit 104. A passive wireless i/f 102 can operate according to any suitable wireless signal or protocol capable of providing data and power necessary for operations as described herein. In some embodiments, a wireless signal can be a radio frequency (RF) signal. In very particular embodiments, a passive wireless i/f 102 can include a RF identification (RFID) transponder, and operate according to a predetermined RFID protocol.

A wireless processor circuit 104 can extract data from data signals received from passive wireless i/f 102 to provide control and/or data values to system logic and storage 108. Similarly, wireless processor circuit 104 can format data received from system logic and storage 108 for subsequent transmission by passive wireless i/f 102.

Meter i/f 106 can receive meter signals from a metering device. Such metering signals can indicate a metering event and information to be stored in response to such a metering event. In some embodiments, meter i/f 106 can receive both meter signals and power from a metering device. However, in alternate embodiments, meter i/f 106 can also derive power from a received meter signal, and so can include a meter signal energy harvesting circuit 116. Thus, as shown in FIG. 1, meter i/f 106 can provide power to power management circuits 110, as well as provide data signals to system logic and storage 108. In some embodiments, meter i/f 106 can receive predetermined signals that indicate particular operations for execution within system logic and storage 108. For example, rather than provide data to be written into a storage location, a meter i/f 106 can provide a signal to indicate that data already stored at a location is to be altered (e.g., increment, decrement or any other arithmetic or logic operation).

System logic and storage 108 can execute predetermined operations that can store and/or recall data from nonvolatile storage circuits in response to accesses from passive wireless i/f 102 or meter i/f 106. According to some embodiments, all or a portion of the operations executed by system logic and storage 108 can be performed using power provided from interfaces (102, 106). Thus, a system 100 can have modes of operation that are completely self-powered. In particular embodiments, accesses from passive wireless i/f 102 can be powered from the corresponding wireless signal, while accesses from meter i/f 106 can be powered from the corresponding meter event. System logic and storage 108 can include nonvolatile storage for retaining data values in absence of power. In some embodiments, such storage can be one or more arrays of nonvolatile memory cells. However, in other embodiments, such storage can be logic circuits with integrated nonvolatile elements (e.g., flip-flops, latch circuits, or the like).

Power management circuits 110 can receive power from passive wireless i/f 102 as well as meter i/f 106. Such power can be provided to system logic and storage 108 to enable accesses to stored data, and optionally, to wireless processor circuit 104. In some embodiments, power management circuits 110 can provide power to other portions of the system; as such power is received at an interface (e.g., 102, 106). However, in other embodiments, power management circuits 110 can include power storage elements (e.g., capacitors, supercapacitors, batteries, mechanical storage) to apply received power over time and/or to retain any excess power not used by an access. Power management circuits 110 can include any suitable power conditioning circuits (e.g., regulators) to provide operating voltage(s) for components of the system 100. As noted above, according to some embodiments, accesses via each interface (e.g., 102/106) can be powered with power received from the same interface. However, in alternate embodiments, power received at one interface can be used for access via another interface (e.g., the accesses are close to one another in time).

According to some embodiments, a system 100 can be formed entirely with integrated circuit (IC) devices.

Referring to FIG. 2, a system 200 according to another embodiment is shown in a block schematic diagram. In one particular embodiment, system 200 can be one particular implementation of that shown in FIG. 1.

System 200 can include RFID analog interface circuits 202, an RFID protocol processor circuit 204, a meter i/f 206, a system logic and storage 208, and power management circuits 210. System logic and storage 208 can include a logic section 216 and a nonvolatile memory 218. RFID analog interface circuits 202 can be connected to an RFID antenna 220. Meter i/f 206 can be connected to a passive meter device 222.

In a particular embodiment, system 200 can utilize RFID techniques, with RFID analog i/f circuits 202 and RFID protocol processor 204 (RFID front end) and system logic and storage 208 operating as a passive RFID transponder. The RF front end (202/204) section can capture energy from an incident RF signal and convert such energy into a voltage that is used to run the system logic and storage 208. The RF signal can also be used to communicate data into and out of the nonvolatile memory 218. In this way, data can be stored into the nonvolatile memory 218 and retrieved from the nonvolatile memory 218 without the use of a battery or other local power.

In more detail, RFID analog interface circuits 202 can receive an RF signal, passively extract power and data from such a signal, providing the data as a serial bit stream to RFID protocol processor 204 and power to power management circuits 210. RFID protocol processor 204 can process a received bit stream, and extract command and/or data from the bit stream, and forward such data to logic section 216. According to a predetermined protocol, logic section 216 can generate a suitable response, which can be sent to the RFID protocol processor 204, formatted, and send to RFID analog i/f circuit 202 for transmission over RFID antenna 220. Such a response can be as simple as an acknowledgement or can be more complex (e.g., authentication, or procedures requiring multiple receive/transmission steps). Based on control data in a received RF signal, logic section 216 can perform operations, including accesses to nonvolatile memory 218. In particular embodiments, such operations can be executed solely according to power provided from an RF signal.

A passive metering device 222 can capture energy from a metering event, which can include any suitable transducer for converting energy of one type into electrical energy, including but not limited to magnetic (including mechanical electro-magnetic), piezoelectric, thermoelectric, photovoltaic, etc. Such captured energy can be forwarded to meter i/f 206 along with a meter data signal.

Logic section 216 can include logic for executing any RFID protocols and accessing nonvolatile memory 218. In addition, logic section 216 can include logic for performing other system functions, including but not limited to, power-on operations, system check/update operations, and power-down operations. It is understood that logic can include, but is not limited to, any of: application specific logic circuits, programmable logic circuits, and processor circuits with corresponding instructions for execution.

Nonvolatile memory 218 can include one or more arrays of nonvolatile memory cells having storage locations for storing meter and other data. Nonvolatile memory 218 can include nonvolatile memory cells of any type suitable to allow operations in response to power received over interfaces (220, 222). In particular embodiments, nonvolatile memory 218 can include ferroelectric random access memory (FRAM) type memory cells, for very low power operations. It is understood that while embodiments can include FRAM type cells in a random access memory array configuration, such FRAM type cells can be arranged in different memory architecture types.

Power management circuits 210 can provide power to various blocks of the system 100 as described for 110 in FIG. 1, or an equivalent.

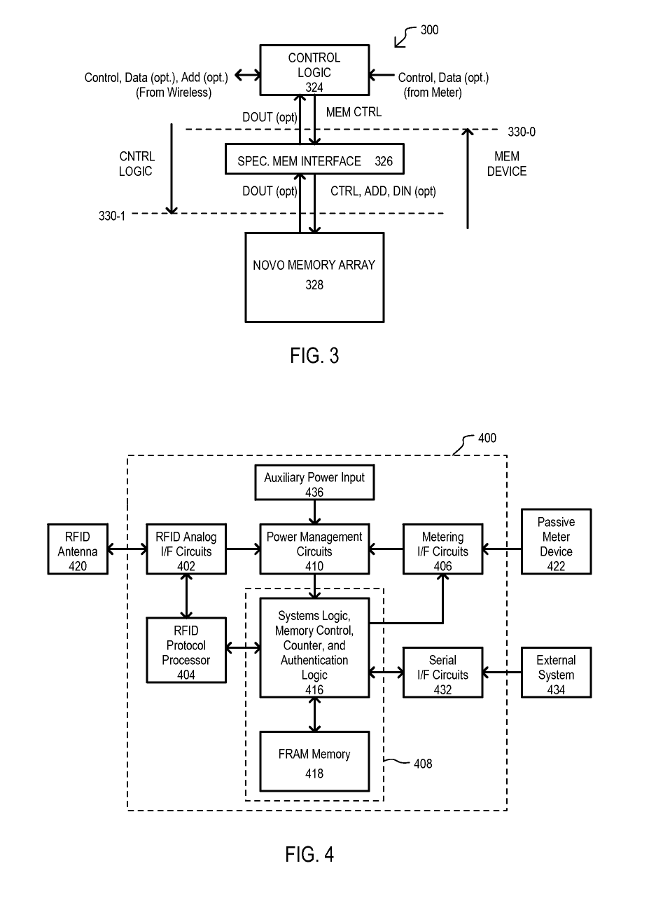

FIG. 3 shows logic-memory interfaces 300 according to various embodiments. Logic-memory interfaces 300 can exist between a logic section (e.g., 216) and a nonvolatile memory (e.g., 218). An interface 300 can include control logic 324, a specialized memory i/f 326, and a nonvolatile memory array 328.

Control logic 324 can receive control values generated from a wireless or meter i/f (no shown). Optionally, control logic 324 can receive data and/or address values from such interfaces. In response to such values, control logic 324 can generate memory control signals and/or data signals.

A specialized memory i/f 326 can generate memory array access signals, including sequences of such access signals, in response to control values received from control logic 324. In some embodiments, a specialized memory i/f 326 can include registers, latches or other storage circuits for operating on data from nonvolatile memory array 328.

A nonvolatile memory array 328 can include one or more memory cell arrays, as well as conventional access circuits, such as address/command decoders, timing signals, read and write circuits, etc.

Line 330-0 shows one interface option in which specialized memory i/f 326 and nonvolatile memory array 328 can be part of a memory device, while control logic 324 can be part of a separate device. As but one example, such a memory device can be separate memory IC device that can be connected to a logic circuit. In the option 330-0, a memory device can include “built-in” specialized memory i/f 326 to generate control signals for accessing nonvolatile memory array 328. A specialized memory i/f 326 can enable an automatic arithmetic or logic functions to be performed at predetermined memory locations in response to input signals. In a very particular embodiment, a memory i/f can enable one or more automatic incrementing functions to be performed at memory locations. Thus, in response to one or more input control values, memory i/f 326 can generate the write and address signals needed to increment a particular value. In some embodiments, such an operation can include read-modify-write operations, where a data value is read from a location of nonvolatile memory array 328, modified (e.g., incremented), and then the new value is written back into the same location.

Line 330-1 shows one interface option in which specialized memory i/f 326 and control logic 324 can be part of a same control device. As but one example, such a control device can interface with a separate memory IC device that includes nonvolatile memory array 328 and a “standard” memory interface that requires address and control signals. Thus, in option 330-1, logic generates the signals necessary to enable automatic arithmetic or logic functions to be performed at predetermined memory locations in response to input signals.

It is understood from FIG. 1 that while FIG. 3 shows an arrangement in which control logic 324 and nonvolatile memory array 328 can be formed in different IC devices, in other embodiments, all the blocks in FIG. 3 can be formed in a same integrated circuit device.

Referring to FIG. 4, a system 400 according to another embodiment is shown in a block schematic diagram. In one particular embodiment, system 400 can be one particular implementation of that shown in FIG. 2.

System 400 can include sections like those of FIG. 2, including RFID analog interface circuits 402, an RFID protocol processor circuit 404, a meter i/f 406, a system logic and storage 408, and power management circuits 410. Such sections can operate in the same or equivalent manner as those of FIG. 2.

FIG. 4 differs from FIG. 2 in that a system 400 can further include a serial i/f 432 which can connect to an external system 434, and logic and storage 408 can include a non-volatile memory (e.g., FRAM memory 418). In addition, a system can include an auxiliary power input 436.

A serial i/f 432 can enable external system 434 to access the system 400. A serial interface 432 can operate according to any suitable serial communications protocol, including but not limited to I2C, SPI, USB, etc. A serial interface 432 can be used for any other kind of sensor input, either as a slave to another device (e.g., microcontroller) or as a master to a standard sensor or other network.

FRAM memory 418 can have very low power requirements as compared to other memory types, and so can be particularly suitable for operations relying harvested or other limited power supplies. In particular embodiments, FRAM memory 418 can have a built-in incrementing interface, to enable accesses via meter i/f 406 to continuously update a count value as meter events occur.

According to some embodiments, an FRAM memory 418 can have hard or soft partitions (maps) to reserve space for counter functions, system parameters and standard storage. The system parameters can include configuration bits which act like a one-time programmable (OTP) memory and can be used to enable/disable internal features, lock out test modes and other personalization functions.

An auxiliary power input 436 can receive power from an external source in addition to power scavenged from an RF signal or received from a passive meter device 422. As but a few examples, an auxiliary power input 436 can receive power from a battery, another device connected to the system (e.g., external system 434) or some local generated source. Auxiliary power from input 436 can be utilized in cases where scavenged/received power is not sufficient and/or for special operations (i.e., maintenance, access from an external system, etc.).

Referring still to FIG. 4, logic section 416 can include logic for controlling FRAM memory 418, counter logic for implementing meter driven counting events, and authentication logic, which can form part of an RFID transponder, in conjunction with RFID analog circuits 402 and RFID protocol processor 404.

An embodiment like that of FIG. 4 can serve to monitor a meter flow. That is, a passive meter device 422 can be a meter that monitors a flow (e.g., water or other fluid).

In particular embodiments, a system 400 can utilize RFID techniques, passive metering, authentication, and FRAM technology for metering applications that are both solid state, and do not necessarily require a local power source to operate.

In one embodiment, a passive metering device 422 can capture energy from magnetic or piezoelectric sources powered by fluid flowing through a pipe. The passive metering device can be powered up when fluid flows through the pipe it is attached to it. In response to such flow, passive metering device 422 can generate an input signal for meter i/f 406 that can result in a count being incremented at a rate proportional to the amount of fluid flowing in the pipe. Such a count can be stored in FRAM memory 418 each time the counter increments. If fluid stops flowing, the count value remains stored, in a nonvolatile fashion within FRAM memory 418. When fluid starts flowing again the count continues from where it left off.

In the embodiment shown, a system 400 can use an RFID protocol to provide authentication from the reader to the RFID to ensure that the meter data is captured securely and as a means of tamper protection. In addition to standard reads and writes, the RFID protocol also allows user specified custom commands, which can be used with a specific, custom reader to enable other secure or supervisory functions.

Having described a system 400 according to an embodiment, possible operations of such a system will now be described. In the description, it is assumed that a system 400 can operate as a zero power non-volatile meter counter.

In operation, fluid can flow past an event detection mechanism. Such a mechanism can generate control values (MP and PP) which can indicate the direction of rotation, as well as a shaped voltage pulse with enough energy to perform an update to the FRAM memory 418. These functions can be provided from, for example, a Hall sensor and a Wiegand Wire based element with associated controller. In the absence of such a self-powering meter mechanism, the auxiliary power input 436 could provide power to enable the counter operation. If the fluid passage is such that a uni-directional flow is guaranteed, one of the two directional inputs can be connected to a constant value.

As an alternative to the counting architecture described above, which can access to a nonvolatile memory array IC device, alternate embodiments can include a standard counter architecture where the traditional logic circuits (flip-flops) can be replaced with non-volatile flip-flops which use a built-in local nonvolatile (FRAM) elements. In this case, an FRAM block can be accessed in a standard random access memory fashion, without the enhancements to support the automatic counting behavior. If FRAM elements are included, anti-imprint methods (noted below) can be used.

On the RF side, conventional RFID behaviors can be provided by a system 400. A system 400 can begin to harvest power and look for proper protocol control words as soon as an RF source is detected. Power management circuits 410 can ensure that appropriate and sufficient voltages are available for each logic or memory block as necessary. Once the authentication and access controls are satisfied, an RFID reader can interrogate a system 400, to extract count values from a FRAM memory 418, as well as perform any number of other administrative functions (zero the counter, write a time/date stamp). If encryption or hashing is included, logic section 416 can be used for such tasks. As noted earlier, an RF protocol which allows for custom commands can use those commands to allow access to critical functions to only those with an appropriate reader which can generate the custom command and utilize it within the protocol.

In this way, a system 400, operating as a passive metering device can operates in much the same way as a conventional RFID transponder except that it can further capture energy from other sources (e.g., magnetic, piezoelectric) powered by fluid flowing through a pipe

In some embodiments, a system 400 can implement an RFID protocol to provide authentication from the reader to the system 400 to ensure that the meter data is captured securely and as a means of tamper protection. In addition to standard reads and writes to FRAM memory 418, such an RFID protocol can also allow user specified custom commands, which can be used with a specific, custom reader to enable other secure or supervisory functions.

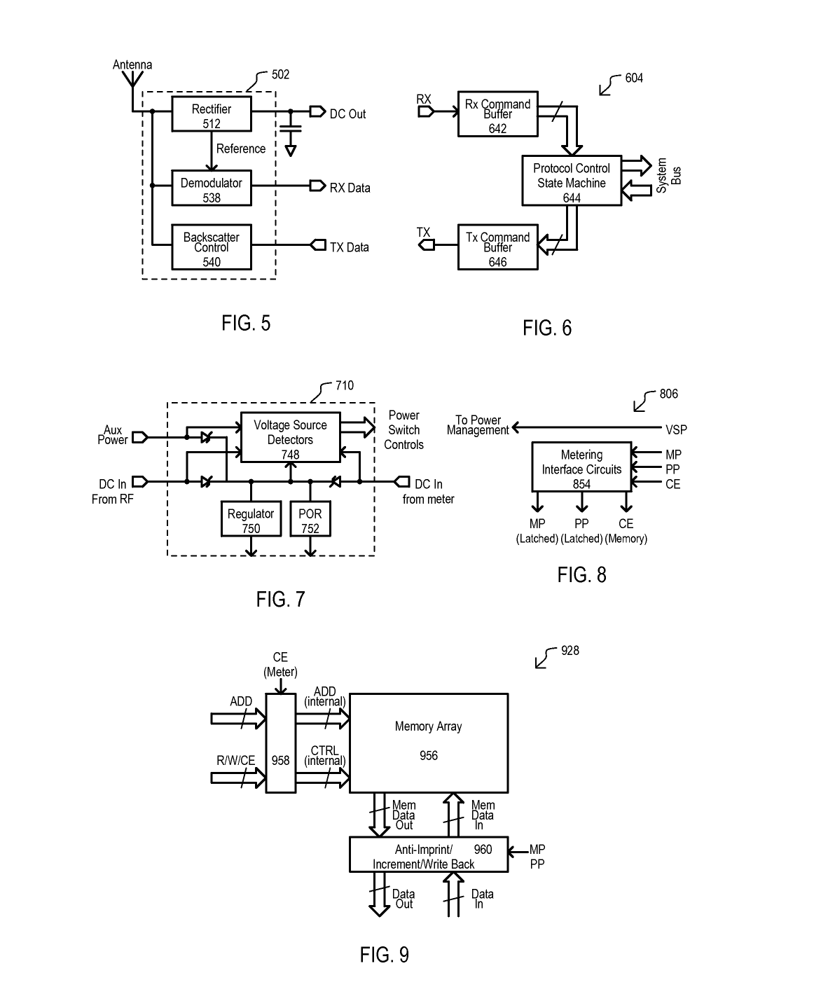

FIG. 5 shows one particular example of RFID analog i/f circuits 502 that can be included in embodiments. RFID analog i/f circuits 502 can include a rectifier section 512, demodulator section 538, and backscatter control 540. A rectifier section 512 can be a harvesting circuit that can rectify incident RF signals to produce a working voltage which can serve as the operating power and other reference voltages for a larger system as described herein. In the embodiment shown, rectifier section 512 can provide a DC output voltage. A demodulator section 538 can extract a command bit stream generated from an RFID reader generating the RF signal, and can provide baseband digital bits for subsequent capture and command interpretation. Thus, a demodulator section 538 can provide receive data (RX Data). A backscatter control 540 can include structures and circuits for generating a passive response to an RFID read via backscatter coupling. In the embodiment shown, backscatter control 540 can receive transmit data (Tx Data) for transmission out from the system.

FIG. 6 shows one particular example of a RFID protocol processor 604 that can be included in embodiments. RFID protocol processor 604 can include a receive (rx) command buffer 642, a protocol state machine 644, and a transmit (tx) command buffer 646. A rx command buffer 642 can receive a serial bit stream from an RF analog i/f and format it appropriately for protocol state machine 644.

Protocol state machine 644 can validate received command words, and can separate commands and data according to one or more protocols. According to the protocol in use, a protocol state machine 644 can execute a small or large number of steps, including those necessary to authenticate and communicate with an RFID source device (e.g., reader). Protocol state machine 644 can also format return messages and control signals for a backscatter mechanism within an RFID analog i/f circuits (e.g., 402). In the embodiment shown, protocol state machine 644 send and receive data to control logic of a system via a system bus.

FIG. 7 shows one particular example of a power management circuits 710 that can be included in embodiments. Power management circuits 710 can include voltage source detectors 748, a regulator circuit 750, and a power-on reset circuit 752. Power management circuits 710 can provide voltage as needed by other sections of a system. Such supply voltages can be at different magnitudes, and can be filtered, regulated or limited. A voltage source detector 748 can detect when a power supply voltage is received. In the embodiment shown, voltage source detector 748 can detect power received from an RF signal (DC In From RF), from an auxiliary power supply input (Aux Power), and from a meter (DC In From meter). When a voltage is detected, an appropriate supply voltage can be provided to regulator circuit 750.

Regulator circuit 750 can provide one or more regulated voltages for a system based a received voltage from voltage source detector 748. A power-on reset circuit 752 can generate control signals for initiating a state of system upon power up, and/or which give indication of the quality or suitability of the supply for use by the various blocks of a system. In particular embodiments, such signals can be for different integrated circuit devices. As but one example, an FRAM Memory can have different minimum operating requirements than other simple digital circuits.

FIG. 8 shows one particular example of a meter i/f 806 that can be included in embodiments. In the embodiment shown, a meter i/f 806 can receive a power supply voltage (VSP), and can include meter i/f circuits 854. Power supply voltage VSP can be generated by the meter from a metering event, and provided as an input to power management circuits. Meter i/f circuits 854 can receive meter signals (MP, PP), which can be digital signals indicating a metering event. In some embodiments, such signals can indicate a data value stored in a nonvolatile location, is to be incremented.

In a particular embodiment, metering i/f circuits 854 can a gather meter information (e.g., for fluids, direction and speed) from an external meter mechanism (which can also provide the energy collected by the mechanism, VSP). Values MP and

PP can be inputs from the external signal conditioning application specific IC (ASIC). Both values can be latched according to signal CE and driven to a counting circuit in a system (which can be part of a nonvolatile memory, in some embodiments). Supply power VSP can have a known, shaped energy burst, also provided by the ASIC. Power from VSP can be sufficient in intensity and duration to guarantee a successful count operation.

FIG. 9 shows one particular example of a FRAM memory 928 that can be included in embodiments. An FRAM memory 928 can provide non-volatile storage for counter value (i.e., meter readings), RFID parameters, and other system parameters as necessary. In the particular embodiment shown, FRAM memory 928 can include logic for an incrementor function. Counts can be activated at a single, consistent address, so that an input signal (CE) from a meter interface can generate an address as well as initiate the appropriate memory cycles. As a read from an FRAM memory can be destructive and include a write-back cycle, an incrementing operation can include performing a read operation to get the present count value, applying the increment to the read data as dictated by input signals from a meter i/f (e.g., MP, PP). The incremented value can then be stored back in the FRAM memory with a write back operation. In contrast to such meter accesses, which automatically increment a count value, memory accesses from an RFID interface or serial interface can be conventional random accesses.

The particular FRAM memory 928 of FIG. 9 can include a memory array 956, a specialized control i/f 958, and a specialized data i/f 960. A memory array 956 can include one or more arrays of FRAM type memory cells that form storage locations. A specialized control i/f 958 can translate control inputs into memory array access values. In particular embodiments, such translation can include generating control inputs for specialized operations (i.e., increment operations). Such inputs can include sequences of read and write operations. In addition, specialized control i/f 958 can enable standard random accesses in response to address and command values.

Specialized data i/f 960 can enable data paths for conventional random access reads and writes, but in addition, can enable specialized operations. In some embodiments, specialized data i/f 960 can include storage circuits to store data values for modification prior to being written back into the memory array 956. In the particular memory of FIG. 9, a specialized data i/f 950 can include known “anti-imprint” circuits. FRAM memories can have a tendency to imprint a value if the data is read and written back to the same value many times. Anti-imprint circuits can introduce an encoding that can cause nearly all bits to change state with each count operation.

In very particular embodiments, an FRAM memory 928 can be implemented by an FM1010 nonvolatile counter produced by Cypress Semiconductor Corporation, located in San Jose, Calif., U.S.A.

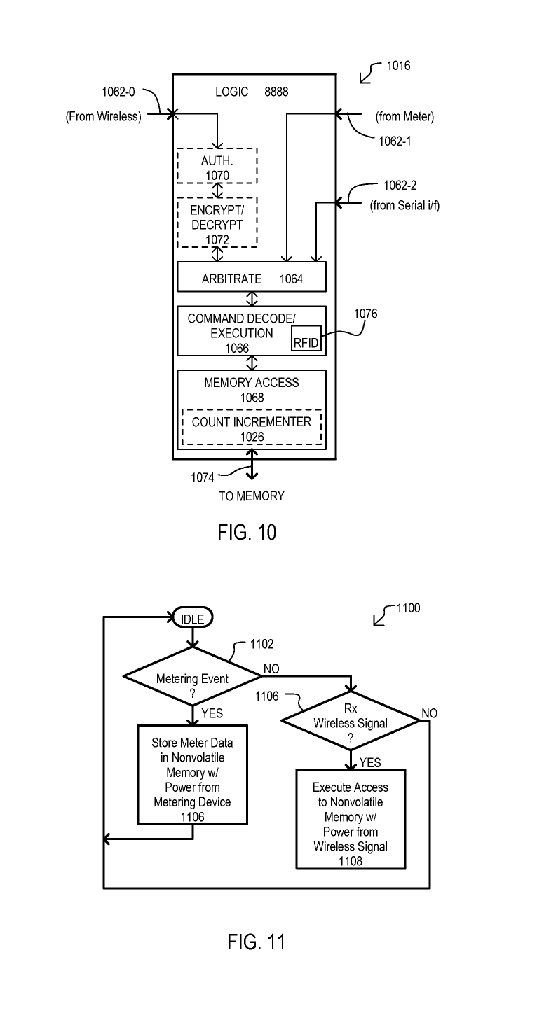

FIG. 10 shows one particular example of control logic 1016 that can be included in embodiments. Control logic 1016 can receive control values generated from a wireless interface 1062-0, control values generated from a meter interface 1062-1, and control values generated from a serial interface 1062-2. Such control values can include data and address values according to the access type. Control logic 1016 can include an arbitration circuit 1064, command decoder and execution circuit 1066 and memory access circuits 1068. Optionally, a control logic 1016 can include encryption/decrypt circuits 1072 and/or authentication circuits 1070. Further, memory access circuits 1068 can optionally include count increment circuits 1026. Control logic 1016 can access a nonvolatile memory via memory access 1074.

Control logic 1016 can control access to a nonvolatile memory, with arbitration circuit 1064 arbitrating between count (i.e., meter i/f) accesses, RF i/f accesses and serial i/f accesses (if included). Command decode and execution circuits 1066 can perform operations in response to accesses via interfaces, where such operations can include writes and reads to a nonvolatile memory. In the embodiment shown command decode and execution circuits 1066 can include RFID protocol control section 1076 to enable RFID communication according to one or more protocols.

Memory access circuits 1068 can generate signals suitable for accessing a nonvolatile memory via memory access 1074. A count increment circuit 1026 can enable specialized accesses, such as increment operations, as described herein, or an equivalent. In some embodiments, a counting instruction to a nonvolatile memory core may be a simple increment, or an increment by two operation. Such operations can arise from existing meter devices having ASICs which can take in data from both a Hall sensor and a Wiegand sensor. Fundamentally, the count detectors can occasionally miss an input, but will be positioned in such a way as to force an increment by two in the next cycle. Accordingly, one of the count bits can be stored in nonvolatile memory to facilitate this.

Optional authentication and encryption/decryption circuits (1070, 1072) can provide additional authentication or security functions that may be extensions of a standard RFID protocol.

Having shown various devices, systems, and methods according to embodiments, additional method embodiments will now be described.

FIG. 11 is a flow diagram showing a method 1100 according to an embodiment. A method 1100 can include determining if a metering event has occurred (1102). Such an action can include detecting predetermined inputs at a meter interface. If a metering event is detected (YES from 1102), meter data can be stored in a nonvolatile memory with power from a metering device (1104). In some embodiments, meter data can be stored using only power from a meter device. It is understood that the storing of meter data can include modifying data according to predetermined procedures (e.g., incrementing).

If a metering event is not detected (NO from 1102), a method 1100 can determining if a predetermined wireless signal is received (1106). Such an action can include detecting predetermined wireless signal (or signals) at a wireless interface. If a wireless signal is detected (YES from 1106), a nonvolatile memory can be accessed with power from the wireless signal 1108.

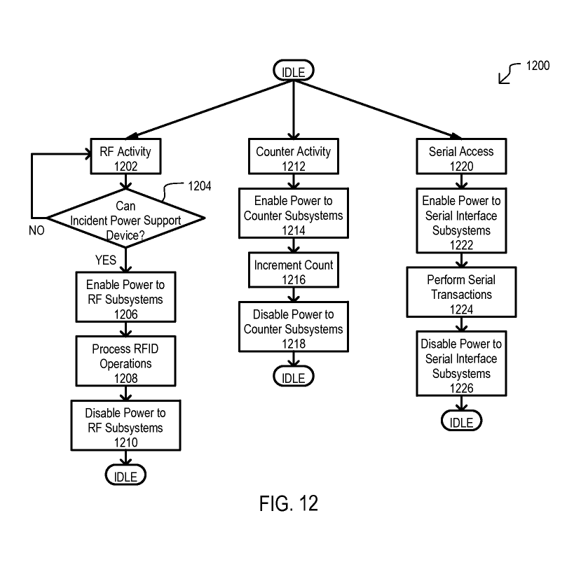

FIG. 12 is a flow diagram showing a method 1200 according to another embodiment. A method 1200 can perform various actions according to a detected activity. If RF activity is detected (1202), a determination can be made whether incident power from an RF signal can support a device operation (1204). If power cannot support an operation (NO from 1204) a method 1200 can return to an idle state. If power can support an operation (YES from 1204) a method can enable power to RF subsystems (1206). It is understood that RF subsystems include those system parts that execute a request received via an RF signal. RFID operations can be processed (1208). This can include power for various circuits, including control circuits and nonvolatile memory circuits. Power for the RF subsystems can then be disabled (1210). A system can then return to an idle state.

If counter (e.g., meter) activity is detected (1212), power can be enabled to counter subsystems (1214). As in the case of RF subsystems, counter subsystems include those system parts that execute a request received via a counter request. A count can be incremented (1216). Such an action can include changing one or more values stored by a nonvolatile memory. Power for the counter subsystems can then be disabled (1218), and a system can then return to an idle state.

If serial access is detected (1222), power can be enabled to serial interface subsystems (1222). Serial interface subsystems can include those system parts that execute a request received via a serial i/f. Serial transactions can be performed (1224). Power for the serial interface subsystems can then be disabled (1226), and a system can then return to an idle state.

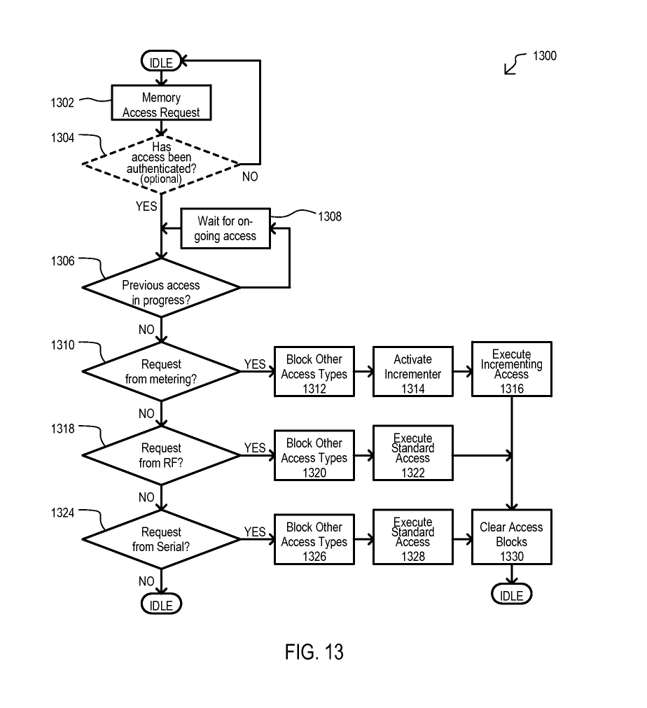

FIG. 13 is a flow diagram showing a method 1300 of arbitrating between different access types, according to another embodiment. In the embodiment of FIG. 13, it is assumed that a meter memory access (counting) has a highest priority, and if such an access is in progress, serial or RF access will be denied. Such an approach can be based on assuming that a meter event is the most finite. However, alternate embodiments can include different priorities and/or different expected power profiles for access types. Thus, FIG. 13 is understood to be illustrative, and other embodiments can include other priorities.

In FIG. 13, RF accesses can be given second priority, and serial access lowest priority. When access is denied for an RF operation, the request is simply ignored. However, in other embodiments, the RF protocol can send back an error message. In some embodiments, to communicate a denied access via the serial port, a status register with a “busy” bit may be used. A serial host can re-try its access when this bit is returned.

A method 1300 can include receiving a memory access request (1302). Such a request can be from any of multiple interfaces of the device, including a meter request, RF request, or serial port request. If authentication is required, and the access is not authenticated (NO from 1304), a method 1300 can return to an idle state. If the access is authenticated (YES from 1304), a method 1300 can determine if a previous access is in progress (1306). If a previous access is in progress (YES from 1306), a method can wait for the on-going access to end (1308).

If a previous access is not in progress (NO from 1306), a method can prioritize from among the different types of accesses. If a request is a metering (i.e., highest priority) request (YES from 1310), a method 1300 can block other access types (1312), activate the incrementer (1314), and execute an incrementing access to a nonvolatile memory (1316). Such actions can include executing a counting or incrementing operation according to any of the embodiments described herein, or equivalents. A method can then clear all access blocks 1330 and return to an idle state.

If a request is not a metering request (NO from 1310), a method 1300 can check of the request is from an RF interface (1318). If a request is a from an RF interface (i.e., second highest priority) (YES from 1318), a method 1300 can block other access types (1328) and execute a standard access (1322). Such actions can include any wireless access operations according to the embodiments described herein, or equivalents. A method can then clear all access blocks 1330 and return to an idle state.

If a request is not from an RF interface (NO from 1318), a method 1300 can check if the request is from a serial interface (1324). If a request is from a serial interface (i.e., lowest priority) (YES from 1324), a method 1300 can block other access types (1326) and execute a standard access (1328). Such actions can include any access operations according to the embodiments described herein, or equivalents. A method can then clear all access blocks 1330 and return to an idle state.

It is noted that while authentication (1304) is shown here as a step rather than a process, such an action can take many forms depending on the level of security required. For example, the ISO18000-6C RFID protocol has a relatively simple form of access control built in to the protocol. In some embodiments, this authentication can be extended with custom commands which can enable higher levels of access control. Other embodiments can implement mutual authentication, including shared secrets between a device and requesting device (e.g., RF reader).

It is understood that while embodiments above have shown systems with one type of particular interface, alternate embodiments can include multiple interfaces. As but one example, a system could include more than one RFID interface, with each operating at a different RF frequencies and/or operating according to different protocols. Similarly, according to other embodiments, a system can include multiple serial interfaces (e.g., SPI, I2C, or any other suitable interface) to accommodate different type of hardware to connect to the system.

According to embodiments, a zero-power device can receive and store meter data for subsequent access via a wireless interface. Because such a system is zero power, the need to ingress or egress meter sites for battery replacement can be eliminated and/or battery lifetimes can be greatly increased. The need for local power can be eliminated.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

What is claimed is:

1. A system, comprising:
a radio frequency identification (RFID) antenna configured to receive a wireless radio frequency (RF) signal;
at least one passive wireless interface circuit that generates data from the wireless RF signal and further includes an energy harvesting circuit that generates first operating power from the wireless RF signal;
at least one meter interface circuit configured to receive at least one input signal and second operating power from a metering device; and
logic circuits configured to arbitrate accesses to nonvolatile storage circuits from the passive wireless interface and meter interface circuits using the first or second operating power,
wherein the passive wireless interface circuit comprises a RFID transponder.

2. (canceled)

3. The system of claim 1, wherein:
the energy harvesting circuit comprises a rectifier circuit.

4. The system of claim 1, wherein:
the meter interface circuit is configured to receive at least one data signal corresponding to a metering event and the second operating a power generated from the metering event.

5. The system of claim 1, wherein:
the nonvolatile storage circuits comprise nonvolatile logic circuits having logic circuits with integrated nonvolatile elements.

6. The system of claim 1, wherein:
the nonvolatile storage circuits comprise at least one nonvolatile memory cell array coupled to the logic circuits.

7. The system of claim 6, wherein:
the nonvolatile memory cell array comprises ferroelectric random access memory (FRAM) type cells.

8. The system of claim 6, further including:
incrementing circuits coupled to the nonvolatile memory cell array configured to increment a count value in response a predetermined input signal from the meter interface circuit.

9. A system, comprising:
a radio frequency identification (RFID) antenna configured to receive a wireless radio frequency (RF) input signal;
a first interface circuit configured to derive data values and a first power supply energy from a wireless RF input signal;
a second interface circuit configured to provide meter data and second power supply energy from a meter device;
a power management circuit that generates a power supply voltage in response to the first or second power supply energy; and
a memory circuit, powered by the power supply voltage, and configured to read and write data values to nonvolatile memory cells in response to accesses from the first or second interface circuits,
wherein the first interface circuit comprises a RFID transponder.

10. The system of claim 9, wherein:
the second interface circuit derives the second power supply energy from a received meter signal that also includes the meter data.

11. (canceled)

12. The system of claim 9, wherein:
the first interface circuit further includes a protocol processor configured to extract command and data values from the wireless RF input signal, and transmit data via a wireless output signal.

13. The system of claim 9, wherein:
the memory circuit comprises a ferroelectric random access memory (FRAM) type cell array.

14. (canceled)

15. The system of claim 9, further including:
an auxiliary power supply input configured to receive a third power supply energy; and
the power management circuit further generates the power supply voltage in response to the third power supply energy.

16. The system of claim 9, wherein:
the meter device comprises an energy harvesting circuit that derives energy from an event that is being metered.

17-20. (canceled)

21. A system, comprising:
a radio frequency identification (RFID) antenna configured to receive a wireless radio frequency (RF) input signal;
a first interface circuit configured to derive data values and a first power supply energy from the wireless RF input signal;
a second interface circuit configured to provide meter data and second power supply energy from a meter device;
a power management circuit that generates a power supply voltage in response to the first or second power supply energy;
a memory circuit, powered by the power supply voltage, and configured to read and write data values to nonvolatile memory cells in response to accesses from the first or second interface circuits;
a serial interface circuit,
wherein the memory circuit is further configured to read and write data values to nonvolatile memory cells in response to accesses from the serial interface circuit, and the first interface circuit comprises a RFID transponder.

22. The system of claim 21, wherein:
the first interface circuit further includes a protocol processor configured to extract command and data values from the wireless RF input signal, and transmit data via a wireless output signal.

23. The system of claim 21, wherein:
the memory circuit comprises a ferroelectric random access memory (FRAM) type cell array.

24. The system of claim 21, further including:
an auxiliary power supply input configured to receive a third power supply energy, and
the power management circuit further generates the power supply voltage in response to the third power supply energy.
